(19) United States
(12) Patent Application Publication
(10) Pub. No.: US 2026/0222227 A1
(43) Pub. Date: Jul. 30, 2026

(54) SECURE INTERACTION SYSTEM USING MULTIPLE USER DEVICE INTERACTIONS

(71) Applicant: Visa International Service Association, San Francisco, CA (US)

(72) Inventor: Yuexi Chen, San Francisco, CA (US)

(73) Assignee: Visa International Service Association, San Francisco, CA (US)

(21) Appl. No.: 19/146,346

(22) PCT Filed: Jan. 18, 2023
(86) PCT No.: PCT/US2023/060856

§ 371 Date: Jul. 8, 2025

(51) Int. Cl. H04L 9/32; H04L 9/00

(52) U.S. Cl. CPC H04L 9/3247; H04L 9/3271; H04L 9/50

(57) ABSTRACT

A method includes receiving from an access device in a transaction, a transaction value and a second address associated with the access device in a first interaction between the user device and the access device. The method also includes outputting the transaction value, and then generating a digital signature by signing a first address associated with the user device, the second address associated with the access device, and the transaction value with a user device private key associated with the first address. The user device then transmits, to the access device, a response message comprising the digital signature and the first address associated with the user device in a second interaction. The access device thereafter processes the transaction using the digital signature, the first address associated with the user device, the second address associated with the access device, and the transaction value.

### CROSS REFERENCE TO RELATED APPLICATIONS

None.

### BACKGROUND

Cryptocurrency transactions can have advantages over traditional types of transactions such as credit and debit card transactions. For example, cryptocurrency transactions such as Bitcoin transactions can be conducted using a public blockchain. They can be recorded on the blockchain and verified by various participants. The blockchain can be an open ledger for transactions and is immutable, thus making alteration of the ledger very unlikely or nearly impossible.

However, cryptocurrency transactions have a number of disadvantages. One disadvantage is that cryptocurrency transactions require the use of relatively sophisticated computers (e.g., a personal computer or a smartphone) with one or more input devices and one or more output devices. The one or more input devices can be used to enter an address (such as a public key of a receiver or an alias of the public key of the receiver) to transfer an amount of cryptocurrency to as well as the transfer amount. The requirement to use such sophisticated computers can be expensive for the general public and can be a barrier to widespread adoption. The use of such sophisticated computers can also increase cybersecurity risks. For example, it is not uncommon for sophisticated computers such as smartphones and personal computers to be continuously connected to a network such as the Internet. By being continually connected, there is the potential for hackers to gain access to the computers to potentially steal the private keys used to perform the cryptocurrency transactions.

In addition, cryptocurrency transactions do not require a central authority to complete transactions. As a result, it is possible for a person conducting a transaction with a resource provider such as a merchant to lose their cryptocurrency if the resource provider is acting in bad faith. In the cryptocurrency transaction environment, there is currently no certification of resource providers by a central authority to ensure that they are trustworthy. For example, if a resource provider is somehow able to change an amount of a cryptocurrency transaction without the active knowledge of the person that is conducting the transaction with the resource provider, then the person will be unable to reverse the transaction and will have no central authority to appeal to. This raises the risk of fraud and it also decreases the confidence of persons seeking to use cryptocurrencies.

Embodiments of the disclosure address these problems and other problems individually and collectively

### BRIEF SUMMARY

One embodiment of the invention includes a method comprising: receiving, by a user device from an access device in a transaction, a transaction value and a second address associated with the access device in a first interaction between the user device and the access device; responsive to receiving the transaction value, outputting, by the user device, the transaction value; generating, by the user device, a digital signature by signing a first address associated with the user device, the second address associated with the access device, and the transaction value with a user device private key associated with the first address; and transmitting, by the user device to the access device in a second interaction, a response message comprising the digital signature and the first address associated with the user device, wherein the access device thereafter processes the transaction using the digital signature, the first address associated with the user device, the second address associated with the access device, and the transaction value.

Another embodiment of the invention comprises a user device comprising: a processor; and a computer readable medium comprising code, executable by the processor, for performing operations comprising: receiving, from an access device in a transaction, a transaction value and a second address associated with the access device in a first interaction between the user device and the access device; responsive to receiving the transaction value, outputting the transaction value; generating a digital signature by signing a first address associated with the user device, the second address associated with the access device, and the transaction value with a user device private key associated with the first address; and transmitting, to the access device in a second interaction, a response message comprising the digital signature and the first address associated with the user device, wherein the access device thereafter processes the transaction using the digital signature, the first address associated with the user device, the second address associated with the access device, and the transaction value.

Another embodiment of the invention includes a method comprising: transmitting, by an access device to a user device in a transaction, a transaction value and a second address associated with the access device in a first interaction between the user device and the access device, wherein the user device outputs the transaction value, generates a digital signature by signing a first address associated with the user device, the second address associated with the access device, and the transaction value with a user device private key associated with the first address; receiving, by the access device from the user device in a second interaction, a response message comprising the digital signature and the first address associated with the user device; and processing, by the access device, the transaction using the digital signature, the first address associated with the user device, the second address associated with the access device, and the transaction value.

Yet another embodiment of the invention includes an access device comprising: a processor; and a non-transitory computer readable medium, the non-transitory computer readable medium comprising code, executable by the processor to implement operations comprising: transmitting, to a user device in a transaction, a transaction value and a second address associated with the access device in a first interaction between the user device and the access device, wherein the user device outputs the transaction value, generates a digital signature by signing a first address associated with the user device, the second address associated with the access device, and the transaction value with a user device private key associated with the first address; receiving, from the user device in a second interaction, a response message comprising the digital signature and the first address associated with the user device; and processing the transaction using the digital signature, the first address associated with the user device, the second address associated with the access device, and the transaction value.

These and other embodiments are described in further detail below.

### Terms

A “user device” may be a device that is operated by a user. Examples of user devices may include a mobile phone, a smartphone, a card, a payment card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G, or similar networks), Wi-Fi, Wi-Max, or any other communication medium that may provide access to a network such as the Internet or a private network.

A “user” may include an individual. In some embodiments, a user may be associated with one or more personal accounts and/or mobile devices. The user may also be referred to as a cardholder, account holder, or consumer in some embodiments.

An “access device” may refer to a device used to access something, such as a network or computer system. For example, a point of sale terminal or the phone of a merchant can comprise an access device used to gain access to a payment processing network. An access device may comprise a means by which it can interface with other devices. For example, an access device may include a chip card reader including conductive contacts used to interface with a smartcard user device.

A “transaction type” may refer to an action or influence within a category of actions or influences having common characteristics. Types of transactions can include transactions involving cryptocurrency, debit, credit, a user requesting access to secure data, a secure webpage, partial access to a secure location, full access to a secure location, complete read and write access to a file, and the like.

A “transaction value” may include a value, magnitude, or quantity associated with a transaction. Examples of monetary transaction values are 5 ETH, 1 BTC, and $1. Examples of non-monetary transaction values could be a count of the number of times a building has been entered or tried to have been entered. Another example of transaction values could be a representation of allowing read or write access to computer files.

A “resource” can be something of value to a user. A resource, for example, can include digital items and/or physical items. A resource can be an obtainable item. A resource can be owned by an entity. A resource can be a physical item such as goods. A resource can be a service that is provided by a merchant. A resource can be a digital item such as non-fungible tokens, secure data, etc. Another example of a resource is access to a secure or otherwise access-controlled location.

A “digital signature” can be a type of electronic signature that encrypts documents with digital codes that are particularly difficult to duplicate. A digital signature can allows for a recipient of the signature to have high confidence that the message was created by an authentic sender and was not altered in transit. A digital signature may be used to mathematically verify the authenticity of digital messages, documents, or transactions.

An “address” may include digital data that identifies an intended recipient or source (e.g., such as a source or recipient of transaction value). An intended recipient or source can be a user, a device, or other entity. An address will be unique compared to the other valid addresses on the network. Some examples of addresses can include public keys or derivatives thereof (e.g., hashes of cryptographic public keys).

An “authorization request message” may be an electronic message that requests authorization for an interaction. In some embodiments, an authorization request message can comprise a first address associated with a user device, a second address associated with the access device, a transaction value, and a digital signature of these data elements.

“Authentication data” may refer to information that proves or shows something to be true, genuine, or valid. Authenticating a user may refer to a process of verifying the identity of the user, e.g., verifying that the user is who they claim to be. Authentication data can comprise passwords, secrets, biometric data, etc.

A “blockchain” can be a distributed/decentralized database that maintains a continuously growing list of records secured from tampering and revision. In some embodiments, the blockchain may include a number of blocks of interaction records. Each block in the blockchain can contain a timestamp and a link to a previous block. Stated differently, interaction records in a blockchain may be stored as a series of “blocks,” or permanent files that include a record of a number of interactions occurring over a given period of time. Blocks may be appended to a blockchain by an appropriate node after it completes the block and the block is validated. Each block can be associated with a block header. In embodiments of the invention, a blockchain may be distributed, and a copy of the blockchain may be maintained at each full node in a verification network. Any node within the verification network may subsequently use the blockchain to verify interactions. A blockchain can be stored, maintained, and updated in a distributed manner in a peer-to-peer network.

A “blockchain network” can include a computer network that maintains a blockchain.

A “node” of a blockchain network can be a computer or software node. In some cases, each node in a blockchain network has a copy of a digital ledger or blockchain. Each node checks the validity of each transaction. In some cases, if a majority of nodes say that a transaction is valid then it is written into a block.

“Cryptocurrency” can refer to a digital currency. Cryptocurrency can include a digital currency in which transactions are verified and records are maintained by a decentralized system using cryptography. A cryptocurrency may not need to be maintained by a centralized authority.

A “cryptocurrency blockchain” can include a blockchain that stores cryptocurrency. A cryptocurrency blockchain can be utilized to transfer cryptocurrency from one public address to another public address.

### BRIEF DESCRIPTION OF THE DRAWINGS

FIG. 1 shows a block diagram of a system according to an embodiment.

FIG. 2 shows a flow diagram illustrating a method of interfacing a user device with an access device during a transaction.

FIG. 3 shows a block diagram of a user device according to an embodiment.

FIG. 4 shows a diagram of a user device in the form of a card according to an embodiment.

FIG. 5 shows a block diagram of an access device according to an embodiment.

FIG. 6 shows a block diagram of a portion of a blockchain according to an embodiment.

### DETAILED DESCRIPTION

Embodiments include methods and systems for interacting a user device with an access device more than once (e.g., exactly two times) to perform a transaction. In some embodiments, the user device can be in the form of a card. The card may have a processor and a memory, but may not have range communication capabilities. For instance, the card or other user device form factor may not have the ability to communicate with a cellular network. Embodiments of the invention can have greater transparency, higher security, and wider adoption.

In some embodiments, a user can verify details of an interaction before the interaction is completed. For example, in embodiments, a user can conduct an interaction such as a transaction using a resource provider access device and a user device of the user. The user can receive details of the transaction on their user device from the access device, before authorizing the transaction using their user device. This can be done even if the user device and the access device are in an offline mode (e.g., neither the user device nor the access device is in communication with a remote server or network).

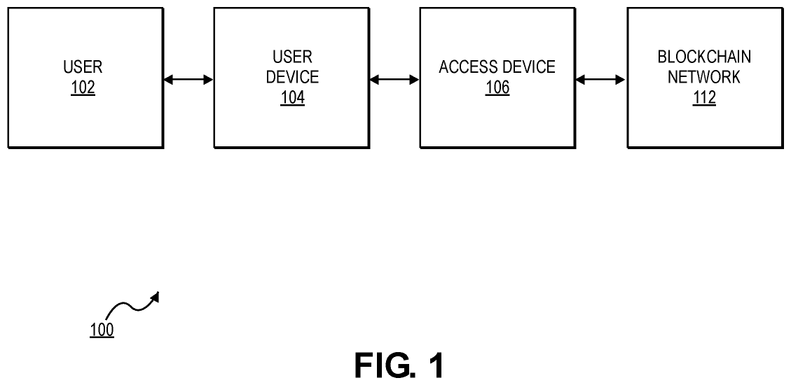

FIG. 1 shows a block diagram of a system 100 according to one of the embodiments. The system 100 includes a user 102, a user device 104, an access device 106, and a blockchain network 112. Each of the devices and computers may be in operative communication with each other. For simplicity of illustration, a certain number of components are shown in FIG. 1. It is understood, however, embodiments of the invention may include more or less components that are illustrated shown in FIG. 1.

The devices and computers in the system 100 can communicate with one another using a communication network or line (not pictured). The communication network or line can take any suitable form, and may include any one and/or the combination of the following: a direct connection or interconnection; the Internet; a Local Area Network (LAN); a Metropolitan Area Network (MAN); an operating Missions as Nodes on the Internet (OMNI); a cellular network, a secured custom connection; a Wide Area Network (WAN); a wireless network (e.g., employing protocols such as, but not limited to a Wireless Application Protocol (WAP), I-mode, and/or the like); and/or the like. Messages between the computers and devices in system 100 may be transmitted using a communication protocol such as, but not limited to, File Transfer Protocol (FTP); Hypertext Transfer Protocol (HTTP); Secure Hypertext Transfer Protocol (HTTPS); Secure Socket Layer (SSL), ISO (e.g., ISO 8583) and/or the like.

The user 102 may operate the user device 104 to obtain a resource from a resource provider operating the access device 106. The user device 104 can interact with (e.g., communicate with) the access device 106 multiple times in a single transaction in embodiments of the invention. In some embodiments, each interaction can be associated with a movement of the user device 104 by the user 102. For example, the user 102 can tap the user device 104 against the access device 106 in first interaction, and tap the user device 104 against the access device 106 in a second interaction. In embodiments, there can be no communication between the user device 104 and the access device 102 between the first and second interactions. In each interaction, the user device 104 and the access device 106 can be in communication with each other and one or many messages may pass between them during each interaction.

The user device 104 may be in any suitable form. For example, the user device 104 may be a mobile phone, wearable device, or a card. For example, the user device 104 can be in the form of a card such as a payment card or an access badge. In some embodiments, the user device 104 is a card that can receive a passcode or biometric template, and compare it to a stored enrollment passcode or biometric template.

In some embodiments, the user device 104 may include a contactless element for interfacing with an access device (e.g., the access device 106). The contactless element may include a chip, and may include the capability to communicate and transfer data using near field communications (NFC) technology or other short-range communications technology. The user device 104 may also include a memory, which may store user information such as an address such as public key, a private key associated with the public key, one or more account numbers, one or more expiration dates associated with the one or more account numbers, a username, etc. If the user device 104 is in the form of a card, it may have printed or embossed information such as a name and account number. In some cases, it may also have a magnetic stripe.

The blockchain network 112 may include a network of computers, which manages and/or stores a blockchain. In some embodiments, the blockchain network 112 can also verify that transactions are valid and can store data relating to transactions. For example, in some embodiments, the blockchain network 112 stores transaction data in the blockchain that it manages. For example, if the user device 104 interacts with the access device 106 in a transaction, the transaction data for the transaction can include data elements such as at least a first address associated with the user device 104 (e.g., a public key associated with a user device 104), a second address associated with the access device 106 (e.g., a public key associated with the access device 106), a transaction value (e.g., 50 USD), and a digital signature of at least the preceding data elements (signed by the private key corresponding to the public key of the user device 104). The preceding data elements may be concatenated together to form a concatenated value, and then signed.

In some embodiments that do not involve financial transactions, the system 100 can allow a user of the user device 104 to access a secure location. In such embodiments, the access device 106 can grant or deny access to the user, based on interactions with the user device 104. The access device 106 can transmit an authorization request message with the transaction data to the blockchain network 112. In such embodiments, the transaction data may include at least a first address associated with the user device 104 (e.g., a public key associated with a user device 104), a second address associated with the access device 106 (e.g., a public key associated with the access device 106), and a transaction value (e.g., the user has entered the secure location or secure data X times), and a digital signature of at least those data elements (signed by the private key corresponding to the public key of the user device 104).

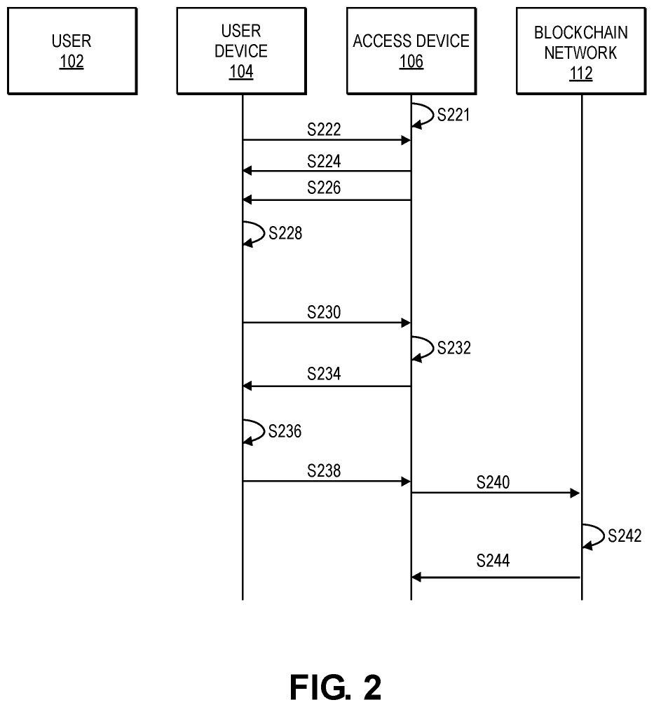

FIG. 2 shows a flow diagram illustrating methods for conducting transactions between a user 102 that operates a user device 104 and a resource provider that operates the access device 106. The system illustrated in FIG. 1 can be used to perform the methods described with respect to FIG. 2.

Prior to step S221, the user 102 may decide to conduct a transaction with a resource provider that operates that access device 106. For example, the user 102 may be purchasing a good or service offered by the resource provider. In other embodiments, the user 102 may seek to access a secure location or secure data provided by the resource provider that operates the access device 106.

In step S221, a transaction value can be generated at the access device 106. For example, a merchant may enter a transaction amount for the item of the good or service to be purchased into the access device 106, or the access device 106 can automatically generate the transaction amount (e.g., after scanning a number of items and totaling the cost of the scanned items).

In step S222, after the access device 106 has received or generated the transaction value, the user 102 can cause the user device 104 to interact with the access device 106 in a first interaction. In some embodiments, the user device 104 can be brought close to the access device 106, such that they communicate through a short range communication protocol such as NFC (near field communication) or Bluetooth™. In some embodiments, in the first interaction, an NFC antenna on the user device 104 receives a signal from the access device 106, which can power the user device 104.

In some embodiments, the user device 104 can provide a list of application identifiers (IDs) associated with applications stored in the user device 104 to the access device 106. Further, in some embodiments, the user 102 or the resource provider can enter a selection of a transaction type (e.g., cryptocurrency, credit, or debit) into the access device 106.

In step S224, while the access device 106 and the user device 104 are in communication with each other, the access device 106 may send a SELECT command to the user device 104 with an AID (application identifier) for a specific application as a cryptocurrency application. For example, the SELECT command can include data such as 00a40400 0b a00000000363727970746f to identify the cryptocurrency application. The user 102 or the resource provider may have previously expressed a preference to the access device 106 that the current transaction is to be conducted using cryptocurrency.

In step S226, while the user device 104 and the access device 106 are in communication with each other in the first interaction, the access device 106 can also transmit data including a second address (e.g., a public key associated with the access device 106 or the resource provider operating the access device 106) associated with the access device 106, a list of transaction types (e.g., credit, debit, and cryptocurrency) capable of being processed by the access device 106, and the transaction value to the user device 104. In some embodiments, if the transaction is a cryptocurrency transaction, an INITIALIZE CRYPTO TRANSACTION command can be sent by the access device 106 to the user device 104 in step S226. Data that can be included in the INITIALIZE CRYPTO TRANSACTION command can be “80a80000 1a 71C7656EC7ab88b098defB751B7401B5f6d8976F000000002300,” in which “71C7656EC7ab88b098defB751B7401B5f6d8976F” is a cryptocurrency address and “000000002300” represents 2300 units of the cryptocurrency as the transaction value.

In step S228, the user device 104 can output information (e.g., a visual output via a display on the user device 104) including the transaction amount and the transaction type of the current transaction. In some cases, step S228 can occur between first and second interactions between the user device 104 and the access device 106, where they are not in communication with each other.

After the transaction amount and the transaction type are output by the user device 104 to the user 102, the user 102 verifies the validity of the output. In some cases, the user device 104 can be a multi-function user device that can have the data needed to perform cryptocurrency, credit, or debit transactions. In other embodiments, the user device 104 may only be configured to perform one type of transaction such as only cryptocurrency transactions.

The user 102 can review the transaction amount and the optional transaction type information that is output by the user device 104 before interacting the user device 104 with the access device in a second interaction to complete the transaction. By doing so, the user 102 can confirm that the resource provider operating the access device 106 has not altered the transaction amount before finalizing the transaction. If the user 102 is not able to verify the transaction amount and the resource provider shows the user 102 one transaction amount but then submits another, the user 102 may have no remedy or authority to appeal to, since many cryptocurrency blockchains are not managed by a central authority. Thus, the ability of the user 102 to review the transaction amount on their user device 104 before taking further steps to complete the transaction improves the security of the system and also improves user confidence in the system.

In some embodiments, the user device 104 is in the form of a card. The card displays the transaction type and transaction amount on the display. Transaction type can be displayed in symbols like “−” for debit and “+” for credit, it can be displayed in text like “Pay,” or symbols like “←” for debit and “→” for credit. In some embodiments, the transaction amount is displayed in numeric units of cryptocurrency, optionally with a symbol of cryptocurrency code in an abbreviation or acronym (e.g., USD, USDC), or symbol ($). Further, in some cases, the cryptocurrency card application calls an API to set the display content after receiving the INITIALIZE CRYPTO TRANSACTION command, e.g., calling javacard API boolean setDisplay (byte [ ] extASCIIString) e.g., setDisplay (“-10.01”.toHexCharArray( )).

If the user 102 agrees with the transaction amount output by the user device 104 and the transaction type, the user 102 can interact the user device 104 with the access device 106 in a second interaction as a step towards completing the transaction. For example, the user 102 can move the user device 104 and can tap the user device 104 against the access device 106 in a second interaction. If the user 102 does not agree with the transaction amount output by the user device 104, then the user 102 will not interact the user device 104 with the access device in a second interaction, and the transaction will then stop or abort.

In step S230, the user device 104 transmits an authentication public key associated with the user device 104 and a challenge code to the access device 106. The authentication public key can be part of an authentication public/private key pair, which can be different than a cryptocurrency transaction public/private key pair associated with the user device 104.

In step S232, after the access device 106 receives the authentication public key and challenge code from the user device 104, the access device 106 generates a data block. The data block can be generated by the access device 106 by concatenating the challenge code with user authentication data (e.g., a PIN, a passcode, a biometric sample, etc.) entered into the access device 106 by the user 102. This can form a concatenated value. After the access device 106 forms the concatenated value, the concatenated value (an example of a data block) can be encrypted with the authentication public key to form an encrypted concatenated value.

In some embodiments, the authentication data may have been directly entered into the access device 106 by the user 102. In other embodiments, the authentication data may have been entered indirectly into the access device 106 through one or more input elements on the user device 104. The user device 104 can receive the authentication data via the one or more input elements, and may then transmit the authentication data to the access device 106, which can then incorporate it into the data block.

In step S234, the access device 106 may send another SELECT command or other message with the encrypted data block to the user device 104.

In step S236, after receiving the encrypted block from the access device 106, the user device 104 may use an authentication private key associated with the authentication public key to decrypt the encrypted data block to obtain the concatenated value and the authentication data entered into the access device 106 by the user 102. The user device 104 can then obtain the challenge code from the concatenated value and can compare it to the challenge code sent, in step S230, from the user device 104 to the access device 106. If there is a match, then the user device 104 can be confident that the transmissions between the user device 104 and the access device 106 are secure.

The user device 104 can also obtain authentication data (e.g., a biometric or password) from the data block. The user device 104 can then compare the authentication data to authentication data stored on the user device 104. If there is a match, then the user device 104 can confirm that an authenticicated user is conducting the current transaction and processing can continue. If there is no match, then the process can be aborted.

Some embodiments of the user device 104 can include a PIN/passcode try counter (or generically an authentication try counter) and try limit programmed into the user device 104. The try counter can be incremented when the PIN/passcode do not match. If the try counter equals the try limit, then the user device can block the user 102 from using a PIN/passcode again until the try counter is reset. The try counter can be reset to zero when the PIN/passcode successfully matches. The try counter can be unblocked and reset by a different PIN/passcode or a different cryptogram/authorization code in some embodiments.

If the challenge and the authentication data are verified by the user device 104 and the user 102 has confirmed the transaction amount, then the user device 104 can generate a digital signature by signing a first address associated with the user device 104 (e.g., a public key associated with a user device 104), the second address associated with the access device 106 (e.g., a public key associated with an access device 106), and the transaction value with a private key associated with the first address which may be a first public key. In some embodiments, the digital signature may further comprise a nonce to prevent replay attacks. These values and optionally other values can be concatenated to form a concatenated value, and the concatenated value can be signed with the private key associated with the first address. In some embodiments, the first address is the public key associated with the user device 104 and the second address is a public key associated with the access device 106.

The user device 104 may then generate a response message comprising the digital signature, the first address associated with the user device 104, the second address associated with the access device 106, and the transaction value. In some embodiments, the response message further comprises the nonce value.

In step S238, the user device 104 transmits to the access device 106, the response message comprising the digital signature and the first address associated with the user device 104. The user device 104 may optionally also send the second address associated with the access device 106, the transaction value, and/or the nonce (if present).

The access device 106 thereafter further processes the transaction using the digital signature, the first address associated with the user device 104, the second address associated with the access device 106, and the transaction value. In some embodiments, the nonce is also transmitted from the user device 104 to the access device 106 as part of the response message.

The access device 106 then receives from the user device 104, the response message comprising the digital signature and the first address associated with the user device 104, and optionally the second address associated with the access device 106, and the transaction value. The access device 106 then further processes the transaction using the digital signature, the first address associated with the user device 104, the second address associated with the access device 106, and the transaction value. For example, in some embodiments, the access device 106 may generate an authorization request message comprising the digital signature, the first address associated with the user device 104, the second address associated with the access device 106, the transaction value, and the optional nonce.

In step S240, after generating the authorization request message, the access device 106 can transmit the authorization request message to the blockchain network 112.

In step S242, the blockchain network 112 can validate the transaction, and write the transaction to a block in the blockchain. Any suitable validation process can be used by the blockchain network 112 to validate the transaction. Examples of validation processes can include consensus processes such as proof of work processes, proof of stake processes, delegated proof of stake processes, etc.

In step S244, the blockchain network 112 can notify the access device 106 after the transaction has been written to the blockchain.

Note that in some cases, the validation of the transaction by the blockchain network 112 may not be in real time, and may take time (e.g., 5-10 minutes). In such embodiments, a separate processing computer (not shown) between the access device 106 and the blockchain network 112 may maintain a separate ledger and may own a sufficient amount of cryptocurrency to pay for the obligations of its users and after performing sufficient risk analyses, may authorize transaction requests while the blockchain network validates transactions. The processing computer may then be reimbursed for any transactions conducted by its users after the blockchain network 112 adds those transactions to the blockchain that it manages.

Variations of the above flow are still within embodiments of the invention. For example, steps S230-S234 can be omitted in some embodiments of the invention.

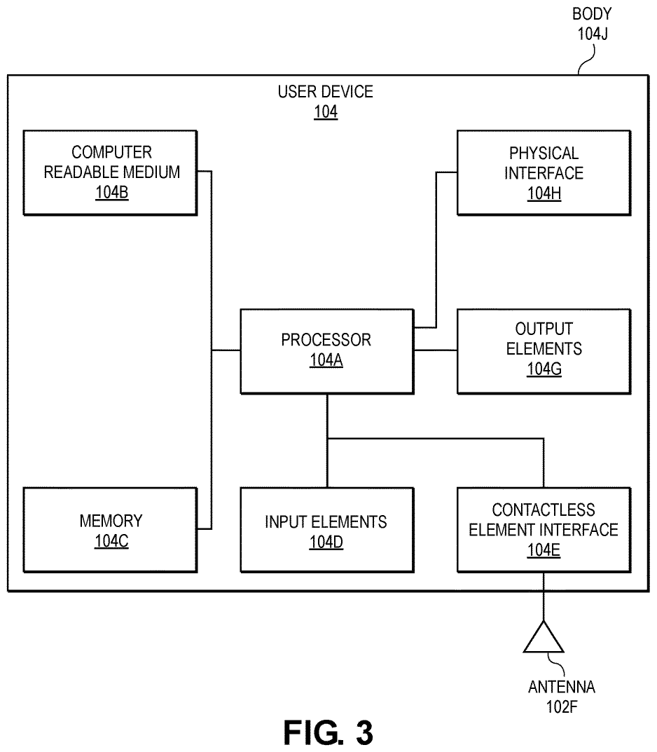

FIG. 3 shows a block diagram of an exemplary user device 104 according to an embodiment.

The user device 104 may include a processor 104A (e.g., a microprocessor) for processing the functions of the user device 104 and output elements 104G (e.g., speaker, display, etc.) to communicate information to a user.

The user device 104 may further include input elements 104D (e.g., a touchscreen, keyboard, touchpad, sensors such as biometric sensors, a microphone, etc.), each of which is operatively coupled to the processor 104A. A contactless element interface 104E, an antenna 104F, a memory 104C, and a computer readable medium 104B may also be operatively coupled to the processor 104A.

The computer readable medium 104B and the memory 104C may be present within a body 104J. The body 104J may be in the form of a plastic substrate, housing, or other structure. In some cases, the memory 104C may be a secure element, and/or may also store information such as access data, including tokens, PANs, tickets, etc. Information in the memory 104C may be transmitted by the user device 104 to another device using an antenna 104F. The user device 104 may use the antenna 104F for wireless data transfer (e.g., using wireless networking protocols such as IEEE (Institute of Electronics Engineers) 802.11) or mobile phone communication (e.g., 3G, 4G, and/or LTE). Antenna 104F of contactless element interface 104E may be an RF antenna. Antenna 104F of contactless element interface 104E may be configured for sending and receiving wireless signals at a frequency specified by different wireless protocols such as NFC (Near Field Communication), BLE (Bluetooth Low Energy), RFID (Radio Frequency Identifier), or any other suitable form of short or medium range communications mechanism. The user device 104 may have more than one antenna.

In some embodiments, the contactless element interface 104E is implemented in the form of a semiconductor chip (or other data storage element) with an associated wireless transfer (e.g., data transmission) element, such as antenna 104F. Data or control instructions that are transmitted via a cellular network may be applied to the contactless element interface 104E. Contactless element interface 104E may be capable of transferring and receiving data using a short-range wireless communication capability. Thus, the user device 104 may be capable of communicating and transferring data or control instructions via both a cellular network (or any other suitable wireless network—e.g., the Internet or other data network) or any short-range communications mechanism.

The computer readable medium 104B may comprise code, executable by the processor 104A, for performing any of the operations described above. In some embodiments, the operations comprise: receiving, from an access device in a transaction, a transaction value and a second address associated with the access device in a first interaction between the user device and the access device; responsive to receiving the transaction value, outputting, by the user device, the transaction value; generating, by the user device, a digital signature by signing a first address associated with the user device, the second address associated with the access device, and the transaction value with a user device private key associated with the first address; and transmitting, by the user device to the access device, a response message comprising the digital signature and the first address associated with the user device, wherein the access device thereafter processes the transaction using the digital signature, the first address associated with the user device, the second address associated with the access device, and the transaction value.

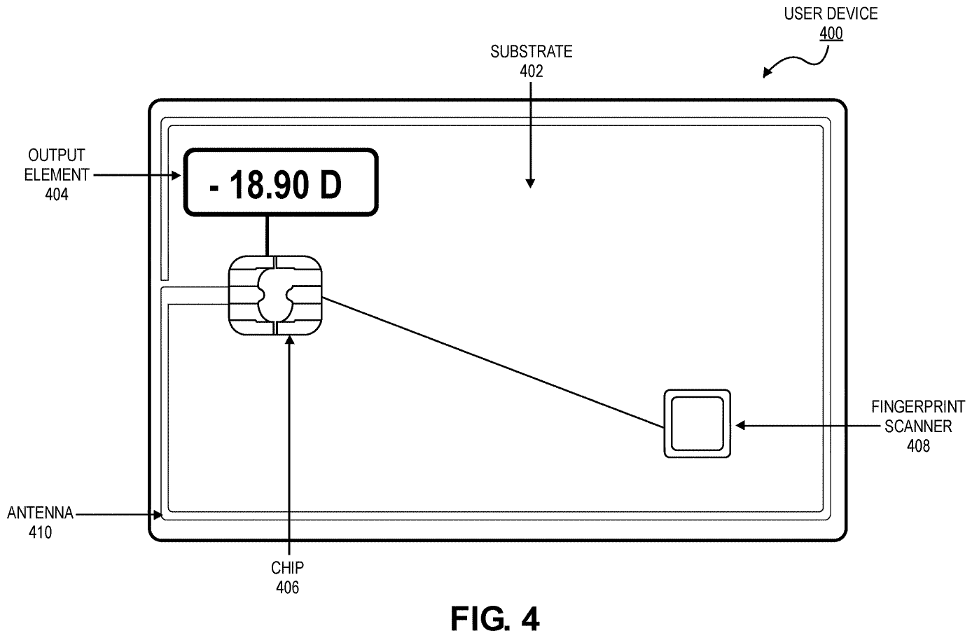

FIG. 4 shows a user device 400 in the form of a card. The user device 400 comprises a substrate 402 such as a plastic substrate. A contactless element for interfacing with a data access or data transfer device may be on or embedded within the user device 400 substrate 402. The contactless element may include a chip 406, and may include the capability to communicate and transfer data using a near field communications (NFC) antenna 410, or other short-range communications technology. The user device 400 may also include a memory (not shown), which may store user information such as a wallet address, a public key, a private key, applications, an account number, an expiration date, and a username. Any of the data, applications, or code in the computer readable medium 104B and/or the memory 104C in FIG. 4 may be present in the memory in FIG. 4. Information may also be printed or embossed on the substrate 402. The substrate 402 may have an input device capable of receiving user authentication data. One example of an input device capable of receiving user authentication data is a fingerprint scanner 408. Further, substrate 402 may have an output element 404 on it. In this example, the output element is in the form of a display.

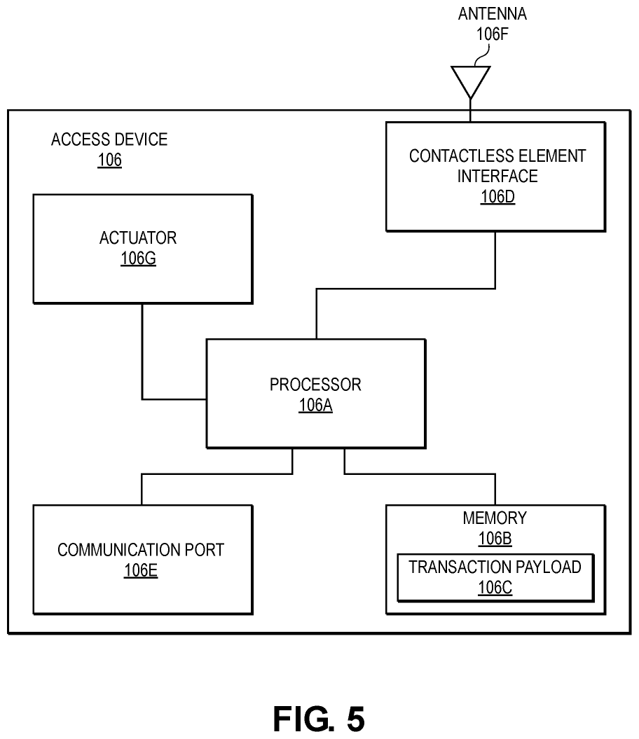

FIG. 5 shows a block diagram of an access device 106 according to an embodiment. Access device 106 includes a processor 106A. The processor 106A may be operatively coupled to a memory 106B which may comprise a transaction payload 106C, a contactless element interface 106D which may include an antenna 106F, and a communication port 106E. Contactless element interface 106D is configured to communicate with (send and/or receive data) the contactless element interface 106D of the user device 104. In one embodiment, the communication port 106E includes hardware to facilitate wireless network communication (e.g., IEEE 802.11). Access device 106 can also include an actuator 106G, such as a mechanical barrier structure that can move after the access device 106 receives an authorization response message with an authorization. Movement of the actuator 106G can allow the user to obtain a desired resource or to access a secure location. The actuator 106G can be a gate device that is a barrier (e.g., a physical barrier), which can allow or not allow users to access secure resources.

Information in the memory 106B may be transmitted by the access device 106 to another device using an antenna 106F. The access device 106 may use the antenna 106F for wireless data transfer (e.g., using wireless networking protocols such as IEEE (Institute of Electronics Engineers) 802.11) or mobile phone communication (e.g., 3G, 4G, and/or LTE). Antenna 106F of contactless element interface 106D may be an RF antenna. Antenna 106F of contactless element interface 106D may be configured for sending and receiving wireless signals at a frequency specified by different wireless protocols such as NFC (Near Field Communication), BLE (Bluetooth Low Energy), RFID (Radio Frequency Identifier), or any other suitable form of short or medium range communications mechanism. Access device 106 may have more than one antenna.

The memory 106B may comprise a computer readable medium comprising code, executable by the processor 106A for performing operations described herein. The operations may comprise: transmitting, to a user device in a transaction, a transaction value and a second address associated with the access device in a first interaction between the user device and the access device, wherein the user device outputs the transaction value, generates a digital signature by signing a first address associated with the user device, the second address associated with the access device, and the transaction value with a user device private key associated with the first address; receiving, from the user device, a response message comprising the digital signature and the first address associated with the user device; and processing the transaction using the digital signature, the first address associated with the user device, the second address associated with the access device, and the transaction value.

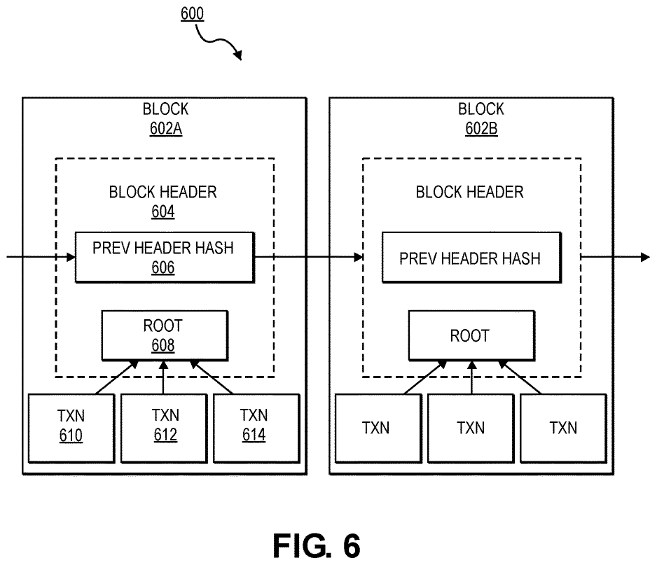

FIG. 6 shows a block diagram illustrating a portion of a blockchain according to embodiments. A blockchain portion 800 can include a list of blocks of transactions, cryptographically chained together. A block can be created by a computationally intensive process called proof-of-work in which valid blocks need to demonstrate a sufficient “difficulty” (e.g., sufficient computation power to create on average). In some embodiments, the first blockchain can utilize a proof-of-stake process rather than a proof-of-work process.

The blockchain portion 600 can comprise a plurality of blocks, for example, block 602A and block 602B. Each block can comprise a block header, for example, block 602A comprises block header 604.

The block header 604 can include multiple data elements, such as a previous header hash 606 and a Merkle root 608. The previous header hash 606 can be a hash of the previous block's header. The Merkle root 608 can be a root of a Merkle tree, which is a tree in which every leaf node is labeled with the hash of a data block, for example, the data in the transactions 610, 612, 614.

Embodiments of the invention have a number of technical advantages. For example, in embodiments, cryptocurrency transactions can be securely performed without any risk that a resource provider may alter a value that will be eventually recorded to a blockchain. Because the user is informed of the transaction amount that is being signed by their own user device, the transaction is secure from tampering by the resource provider. This results in not only improved security, but will also result in a higher degree of confidence in the use of such systems.

In addition, as noted above, embodiments of the invention can use challenge codes and authentication data in the interactions used in the transaction. The challenge codes and authentication data can provide assurance that an authentic user device is being used, and that there is no man-in-the-middle that has intervened in the transaction.

Any of the software components or functions described in this application, may be implemented as software code to be executed by a processor using any suitable computer language such as, for example, Java, C++, or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a user device from an access device in a transaction, a transaction value and a second address associated with the access device in a first interaction between the user device and the access device;
responsive to receiving the transaction value, outputting, by the user device, the transaction value;
generating, by the user device, a digital signature by signing a first address associated with the user device, the second address associated with the access device, and the transaction value with a user device private key associated with the first address; and
transmitting, by the user device to the access device in a second interaction, a response message comprising the digital signature and the first address associated with the user device, wherein the access device thereafter processes the transaction using the digital signature, the first address associated with the user device, the second address associated with the access device, and the transaction value.

2. The method of claim 1, wherein the user device is a card.

3. The method of claim 1, wherein the first address associated with the user device is a user device public key corresponding to the user device private key.

4. The method of claim 1, wherein the user device comprises a display which outputs the transaction value.

5. The method of claim 1, wherein the access device thereafter processes the transaction using the digital signature, the first address associated with the user device, the second address associated with the access device, and the transaction value by transmitting an authorization request message comprising the digital signature, the first address associated with the user device, the second address associated with the access device, and the transaction value to a blockchain network.

6. The method of claim 1, wherein the first address is a public key associated with the user device and the second address is a public key associated with the access device.

7. The method of claim 1, wherein the user device is caused by a user to interact the access device to initiate communication sessions exactly two times in the transaction.

8. The method of claim 7, wherein the first interaction and the second interaction are NFC (near field communication) interactions.

9. The method of claim 1, during the second interaction, the method further comprises:
transmitting an authentication public key and a challenge code to the access device, wherein the access device concatenates the challenge code with user authentication data entered into the access device to form a concatenated value, and encrypts the concatenated value with the authentication public key to form an encrypted concatenated value;
receiving, by the user device, the encrypted concatenated value from the access device; and
decrypting, by the user device, the encrypted concatenated value using an authentication private key associated with the authentication public key to obtain the concatenated value.

10. The method of claim 9, further comprising:
determining, by the user device, that the user authentication data entered into the access device matches corresponding user authentication data stored in the user device, wherein generating the digital signature is performed after the determination that the user authentication data entered into the access device matches the corresponding user authentication data stored in the user device.

11. The method of claim 10, further comprising:
determining that the challenge code that is in the concatenated value matches the challenge code transmitted by the user device to the access device.

12. The method of claim 1, wherein the access device is a terminal that comprises a gate device.

13. The method of claim 1, the response message also comprises the second address associated with the access device and the transaction value.

14. The method of claim 1, wherein the user device is capable of performing different types of transactions with the access device.

15. A user device comprising:
a processor; and
a computer readable medium comprising code, executable by the processor, for performing operations comprising:
receiving, from an access device in a transaction, a transaction value and a second address associated with the access device in a first interaction between the user device and the access device;
responsive to receiving the transaction value, outputting, by the user device, the transaction value;
generating, by the user device, a digital signature by signing a first address associated with the user device, the second address associated with the access device, and the transaction value with a user device private key associated with the first address; and
transmitting, by the user device to the access device in a second interaction, a response message comprising the digital signature and the first address associated with the user device, wherein the access device thereafter processes the transaction using the digital signature, the first address associated with the user device, the second address associated with the access device, and the transaction value.

16. A method comprising:
transmitting, by an access device to a user device in a transaction, a transaction value and a second address associated with the access device in a first interaction between the user device and the access device, wherein the user device outputs the transaction value, generates a digital signature by signing a first address associated with the user device, the second address associated with the access device, and the transaction value with a user device private key associated with the first address;
receiving, by the access device from the user device, a response message comprising the digital signature and the first address associated with the user device in a second interaction; and
processing, by the access device, the transaction using the digital signature, the first address associated with the user device, the second address associated with the access device, and the transaction value.

17. The method of claim 16, further comprising:
generating, by the access device, the transaction value.

18. The method of claim 16, wherein the user device is a card.

19. The method of claim 16, wherein the access device processes the transaction by
generating an authorization request message comprising the digital signature, the first address associated with the user device, the second address associated with the access device, and the transaction value; and
transmitting the authorization request message to a blockchain network, which writes the digital signature, the first address associated with the user device, the second address associated with the access device, and the transaction value to a blockchain that is maintained by the blockchain network.

20. The method of claim 16, wherein the transaction is a transaction to access a secure location, and wherein the access device comprises a barrier that actuates allowing a user of the user device to access the secure location.
